(19) United States
(12) Patent Application Publication
(10) Pub. No.: US 2024/0378029 A1
(43) Pub. Date: Nov. 14, 2024

(54) AUTOMATED AUTHORING OF SOFTWARE SOLUTIONS FROM AN AI-ENHANCED MODEL

(71) Applicant: 27 Software U.S. Inc. dba DXterity Solutions, Mooresville, NC (US)

(72) Inventor: Christopher Zee Chartrand, Brantford (CA)

(21) Appl. No.: 18/650,155

(22) Filed: Apr. 30, 2024

Related U.S. Application Data
(63) Continuation-in-part of application No. 18/286,575, filed on Oct. 12, 2023.
Application No. 18/286,575 is a continuation of application No. 17/232,444, filed on Apr. 16, 2021, now Pat. No. 11,314,489.
Application No. 17/232,444 is a continuation of application No. 17/232,487, filed on Apr. 16, 2021, now Pat. No. 11,693,652.
Application No. 17/232,487 is a continuation of application No. 17/232,520, filed on Apr. 16, 2021, now Pat. No. 11,409,505.
(60) Provisional application No. 63/463,277, filed on May 1, 2023.

(51) Int. Cl. G06F 8/35; G06F 8/36; G06F 8/77

(52) U.S. Cl. CPC G06F 8/35; G06F 8/36; G06F 8/77

(57) ABSTRACT

A method or system uses AI-based enhancement to improve an initial model, such as an abstract model of a database, before the abstract model is submitted to an automated code author. The AI, which may be a generative AI, can assist with identifying parts of the abstract model (such as UML artifacts) and suggest revisions, according to a series of interactions between a developer and AI. The result of this interaction with the AI is then used to revise or augment the abstract model. Ultimately, the AI-enhanced model is consumed by a code author to generate application source code.

### CROSS REFERENCE TO RELATED APPLICATIONS

This application relates to U.S. Pat. No. 11,314,489 entitled “Automated authoring of software solutions by first analyzing and resolving anomalies in a data model”, U.S. Pat. No. 11,693,652 entitled “Automated authoring of software solutions from a data model”, U.S. Pat. No. 11,409,505 entitled “Automated authoring of software solutions from data model with related patterns”, and International Patent Publication WO2022/221610 A1, entitled “Automated authoring of software solutions from a data model”, and is a continuation in part of co-pending U.S. patent application Ser. No. 18/286,575 entitled “Automated Authoring of Software Solutions from a Data Model”. The entire contents of each of these patents and patent applications are hereby incorporated by reference.

### BACKGROUND

There is an ever increasing need to enable enterprise data processing systems to be faster, cheaper, smarter and more convenient to users and customers. Companies, schools, churches, and governments around the world are collectively investing trillions of US dollars each year in technology to become more competitive and more profitable. High quality software applications are core to the success of these digital transformation endeavors.

Quickly-built prototypes of software programs initially prove that new business models can work. The prototypes are typically then re-written into much larger and scalable enterprise software applications. However new software applications can take 18-24 months to construct using teams of developers, and too often the final completed application is overdue, overbudget, does not meet the originally designed purpose, nor does it fully meet the required specifications.

Legacy programs are expensive to maintain, often poorly documented and the programmers who built the programs have either died or retired, making it risky to touch, change, or upgrade those legacy software applications without experienced staff on hand. Old programs create security vulnerabilities, are challenging to move to the cloud environment, and are prone to break, threatening ongoing operations every day. The legacy applications must be replaced.

Software programs need to talk to other software programs more than ever before. To communicate and share data they use software apps, APIs (application programming interfaces), which are complex and specialized, requiring significant time to build.

There is an ever-increasing shortage of competent, experienced programmers. Companies are held hostage by lack of talent. Productivity then suffers, incurring long delays to complete projects, with growing backlogs of projects obstructing competitiveness and profitability. Furthermore, the process to develop software has not fundamentally changed in decades. At their core, software programs are built through writing code “by hand”. By its nature, this process lacks efficiency, lacks excellent comprehensive tools and lacks adherence to common standards. They are often run by individual developers who act more as “artists” who code in their own style.

The above-referenced patents and patent applications describe techniques for automatically generating code and related artifacts such as application programming interfaces (APIs) and related documentation from an abstract model. The abstract model is automatically generated from a source such as a legacy database, an entity relationship diagram, or other schema defining the data tables, objects, entities, or relationships etc. in the source.

The approach may be used to generate code representing full stack enterprise grade source code from the abstract model. The source code may be exposed (that is, made visible to the developer) in its pre-compiled state. The generated code is therefore configurable and extendable via a user interface. Any such extended code is maintained in a structure (such as a file or folder) separately from where the generated code is stored. The extended code structure serves as a location for later placement of developer code. A User Interface (UI), API layer, unit testing, logic tiers, data access layer and related documentation can be automatically generated from the abstract model as part of the full stack enterprise grade solution.

Non-generative Artificial Intelligence (AI) tools and generative AI tools based on Large Language Models (LLMs), including OpenAI's ChatGPT and Microsoft's CoPilot are finding widespread use. Some of these tools provide chat-based interfaces that enable users to refine and steer a conversation towards a result having a desired length, format, style, detail, and language. Successive prompts and replies, known as prompt engineering, are considered at each conversation stage as a context. Although their core function is to mimic a human conversation, these LLMs can perform countless tasks. They can write and debug computer programs, prepare written documents, compose music and student essays, answer test questions (sometimes, at a level above the average human test-taker), generate business ideas, write fiction, poetry and song lyrics, translate and summarize text, emulate data processing systems, among other endeavors.

### SUMMARY

This patent application describes using artificial intelligence (AI) tools to enhance, enrich and augment a model of a data source, computer program, or other data processing artifact. The resulting AI-enhanced model may then be used by a code author to generate code. In one example embodiment, the generated code may consist of base code and an architecture for extended code that together comprise a fully functioning, extensible enterprise-level software solution.

The AI enhanced model provides additional instruction to the code author so that the generated base code requires less code extension in the finalized software solution. The model can be functionally or visually enhanced to create a result that is more consumable and comprehensible to non-programmers.

In one embodiment, the code author may be an AI based code author, and the code author may, in some instances, be the DXterity code author as described in the above-referenced patents and patent applications.

More particularly, in some aspects, the techniques described herein relate to a method or system for generating code, the method including: obtaining an initial model; identifying an artifact of the model; generating an enhancement of the artifact using Artificial Intelligence (AI) tool; revising the initial model according to the enhancement, to produce an AI-enhanced model; and submitting the AI-enhanced model to a code author, thereby generating the code.

In other aspects, the techniques described herein relate to a method or system for generating code from an initial abstract model of a database, including: modifying an attribute of the initial abstract model using an artificial intelligence (AI) tool to produce an AI-enhanced model; generating base application code from the AI-enhanced model; generating an extended application code structure for subsequent placement of extended application code, wherein components of the extended application code may include one or more code extensions, attributes, properties or rules that are specified other than by generating from the AI-enhanced model; storing the extended application code structure separately from the base application code; exposing the base application code and extended application code structure for developer review; and accepting developer modifications, if any, to the base application code; and wherein the code structure further includes patterns that define further aspects of the base application code.

The techniques described herein also relate to a method or system for generating code from an initial abstract model of a database, including: identifying an artifact of the initial abstract model; generating an enhancement of the artifact using an Artificial Intelligence (AI) tool; revising the initial abstract model according to the enhancement, to produce an AI-enhanced abstract model; and submitting the AI-enhanced abstract model to a code author by: generating base application code from the AI-enhanced abstract model; generating an extended application code structure for subsequent placement of extended application code, wherein components of the extended application code may include one or more code extensions, attributes, properties or rules that are specified other than by generating from the AI-enhanced abstract model; storing the extended application code structure separately from the base application code; exposing the base application code and extended application code structure for developer review; accepting developer modifications, if any, to the base application code; accepting developer modifications, if any, to the components of the extended application code structure; accepting developer modifications to the AI-enhanced abstract model to provide a revised model; and regenerating code by: overwriting any developer modifications to the base application code by regenerating the base application code from the revised model; and otherwise preventing any overwriting of the components of the extended application code structure after such developer modification are made to the components of the extended application code.

### BRIEF DESCRIPTION OF THE FIGURES

FIG. 1 is a conceptual diagram illustrating how a platform may generate code from a model of a database artifact, and how the resulting code may be arranged in a hierarchy of code blocks including core, base and extended logic, base and extended APIs, base and extended UIs, documentation, unit tests, and other related components.

FIG. 2 is an example flow for enhancement of an initial model to result in an AI-enhanced model.

FIG. 3 illustrates a hierarchy of functions performed on an abstract model to generate code as an extensible enterprise-level framework, Application Programming Interface (API), User Interface (UI) and related documentation.

FIG. 4 is an example initial model of a database artifact.

FIGS. 5A-5E are an example interaction to add new features to the initial model of FIG. 4.

FIG. 6A-6B illustrates enhancement of a flow in an initial model.

FIGS. 7A-7C shows a functional enhancement to an initial model.

### DETAILED DESCRIPTION OF PREFERRED EMBODIMENT(S)

This patent application describes using artificial intelligence (AI) tools to enhance, enrich and augment an initial model of a data source, computer program or other artifact. The resulting AI-enhanced model is then used by a code author to automatically generate computer code such as source code. The generated source code may be organized as base code with an architecture for placement of extended code. The resulting code may comprise a fully functioning, extensible enterprise-level software solution. The enhancements to the abstract model provide additional instruction to the code author, which itself may be an AI-enabled code author, so that the generated code requires less extension in the finalized software solution. The model may be enhanced in different ways, such as functionally or visually, to result in a model that is more consumable and comprehensible to non-programmers.

As explained above, the present invention relates to a system and methods that consume an initial model of a data source and transforms it into an AI-enhanced model. The model(s) act as an intermediary between data models and/or conceptual entity relationship diagrams and/or abstract models and the resulting generated code. The initial model may then be enhanced using AI.

In one implementation, the enhanced model may be an enhanced abstract model that is then used to generate base code, Application Programming Interfaces (APIs), User Interfaces (UI), documentation, and other elements of an enterprise-level solution. Each of the generated base code, generated base APIs, generated base UIs or other artifacts of the model may also be extended.

Extended elements are maintained in a framework, such as a different source code file, separately from generated based code elements. More details for one example method of generating base and extended code from abstract models using a platform called DXterity are provided in the patents and co-pending patent applications already incorporated by reference above.

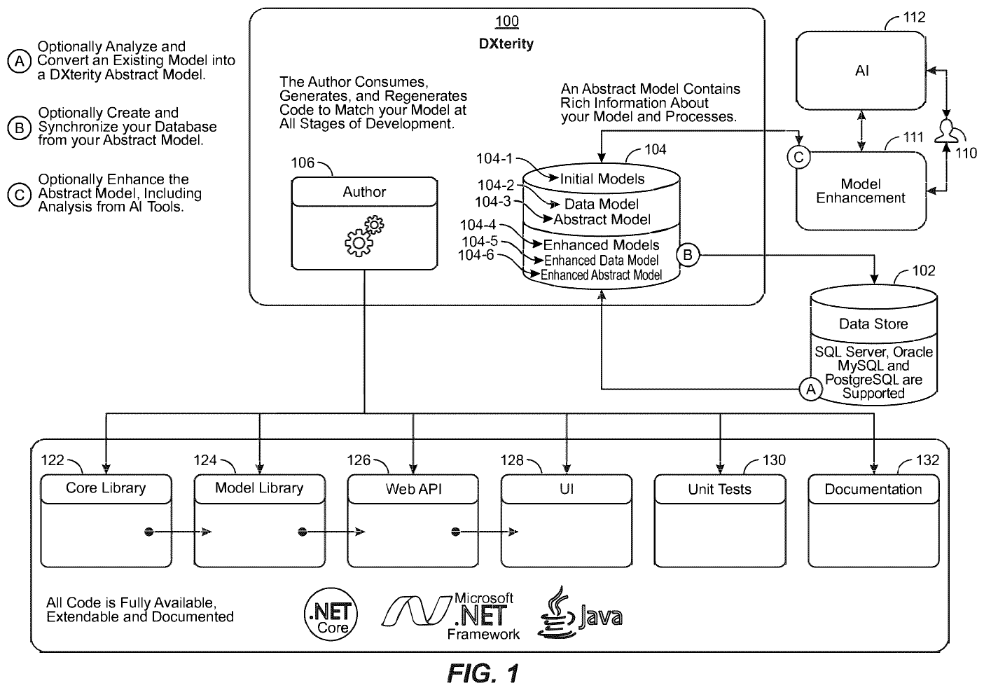

An example implementation will now be described and shown, starting with FIG. 1. Here a data source, such as data store 102, is made available to a productivity platform 100 referred to herein as DXterity. The data store 102 may, for example, be associated with a legacy software application. However, it should be understood that the source may not necessarily be a legacy application but some newer application or the productivity platform may generate a new data store. The data store 102 may be in any common form such as MySQL, SQL Server, DB2, Oracle, Access, Teradata, Azure, PostgreSQL or the like.

The system 100 may operate with various models 104 of artifacts of the data store 102.

To generate code, one or more models 104 are fed to a code author, such as an AI-based code author 106 like the one implemented by DXterity. The author 106 consumes the model(s) 104 to generate and regenerate code to match the model(s) 104. The author 106 may generate the code in certain forms, and may also generate other artifacts related to the model(s) 104. For example, the author 106 may generate or may use a core code library 122 and/or model library 124. But the author 106 may also generate application base logic, a web application interface 126, a user interface 128, unit tests 130, and/or documentation 132 from a model 104 as described in the above-referenced patents and patent applications. In one implementation, one or more initial models 104-1 are determined for some aspect of the data store 102. The initial models 104-1 may include an abstract model 104-3 generated by a tool such as the DXterity 100 platform.

More generally, however, the initial models 104-1 can be any sort of data model 104-2. For example, the initial model 104-1 may be a data model 104-2 designed by a human or built by an AI tool or a data model provided by a tool such as DXterity 100. The data models 104-2 can be available from the data store among other sources like entity relationship diagram, etc. An AI tool 112 could also generate an initial data model 104-2. DXterity can also generate an initial data model 104-2 from an abstract model 104-3.

Abstract models 104-3 may be generated by DXterity 100 starting from a data model 104-2 or can be initialized/configured by the developer 110 using the DXterity platform without a data model.

The initial models 104-1, be they data models 104-2 or abstract models 104-3, may describe the data, metadata and schema details in the data store 102 in a variety of ways, such as via an entity relationship diagram, a Universal Modeling Language (UML) or other notations including behavior diagrams, interaction diagrams, structure diagrams, or the like. In a preferred embodiment, the initial models 104-1 are abstract models 104-3 generated in a particular way by DXterity 100 to help ensure that the resulting code 122, 124 conforms to expected criteria. For example, the DXterity system 100 may be configured to ensure that the resulting generated code and artifacts 122-132 provide an extensible, enterprise-level software solution. As explained in the above-referenced patents and patent applications, this may be accomplished by ensuring that the abstract models 104-3 conform to certain metrics or conventions prior to code generation.

Regardless of whether the initial model 104-1 is a data model 104-2 or an abstract model 104-3, a human software designer/programmer/developer 110 further interacts with a model enhancement function 111 driven by an AI tool 112 to generate AI-enhanced models 104-4. AI-enhanced models 104-4 thus include both enhanced data models 104-5 and enhanced abstract models 104-6, depending on whether the initial model was a data model 104-2 or an abstract model 104-3.

The AI tool 112 may be one based on Large Language Models such as OpenAI's ChatGPT4 or Microsoft's CoPilot, or BERT or Stanford or Rasa or other such tools. Some other examples of generative AI developed by Google include DeepMind and DeepDream. Examples of non-generative AI tools capable of serving as the AI tool 112 include Google TensorFlow, Scikit-Learn, Microsoft Cognitive, and X6Boost. AI tools that leverage chat-based interfaces enable a developer 110 to refine and steer a conversation about the features of the initial model 104-1 to ultimately derive an AI-enhanced model 104-4.

As will be explained in more detail below, model enhancement 111 involves successive prompts and replies (prompt engineering) between the developer 110 and the AI tool 112. In some implementations, the AI tool 112 may implement a learning process that leverages a knowledge base. In other instances, AI tool 112 may be an artificial neural network that uses natural language processing. In still other instances the AI tool may be based on a Generative Pre-trained Transformer (GPT) model.

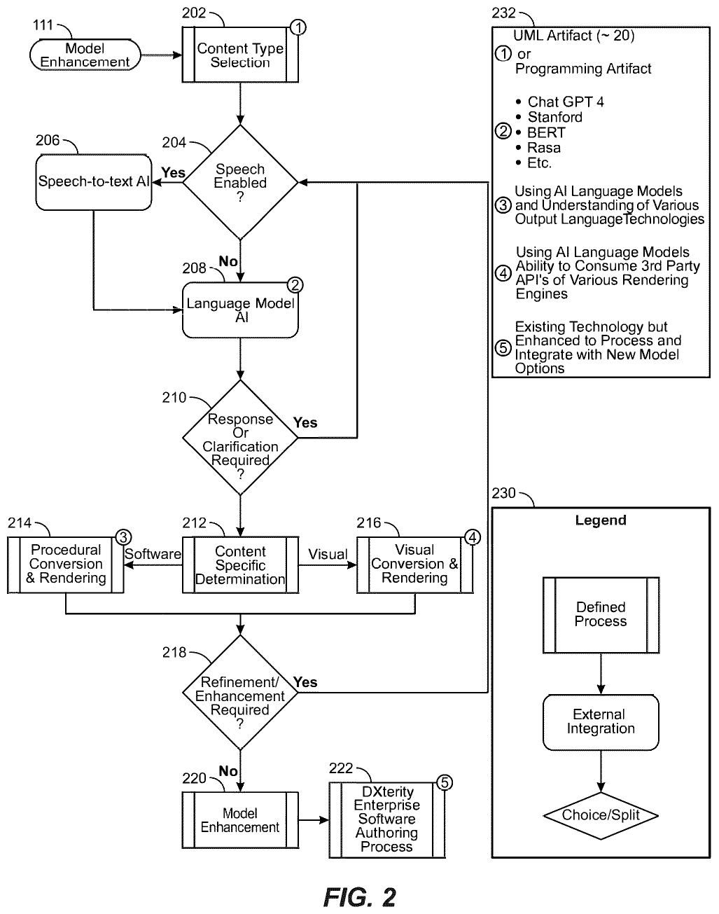

As shown in FIG. 2, an initial step of AI enhancement 111 of the initial model 104-1 may be Content Type Selection 202. A selection could be made from different artifacts such as any Universal Modelling Language (UML) artifacts such as flow diagrams or logical models, or streamlines, or flowcharts, or case diagrams, or class diagrams (definitions) or state diagrams. This first step 202 can be accomplished using speech enabled AI 204 or from speech-to-text 206 tool via a natural language model. These content selection tools may be connected to the model enhancement 111 via a unified interface.

Content selection 202 may involve selecting a part of the initial model 104-1 (which, again, may be an existing abstract model or may involve building or seeding a new model such as a data model). The result in either case is an identified UML artifact or some other programming artifact at 208. This may be any artifact that will be subsequently selected for use by the AI code author 106. In an illustrative example, two types of content specific determinations 212 may be rendered; a visual conversion and rendering 216, as well as a procedural conversion and rendering 214. Both renderings 214, 216 are used by the developer 110 to perfect and fine tune the output as an AI enhanced model 104-4. Content determination 212 may thus identify procedural artifacts such as code snippets that confirm to the user's prompts. The code snippets generated by the AI tool 112 may be selected as available from existing open source or other code libraries, as some examples.

The developer's prompts may also seed the AI tool 112 with further context for the model enhancement 111. For example, the prompts may specify some attribute of the end user of the generated code (their industry, profession, or job description), a location or country of the end user, or the programming language that should be used to render the model(s), or the experience level of the programmer.

In one example use case, subsequent feedback loop and iterative steps through response clarification 210, the visual conversion and rendering 216 provide visualization of an AI enhanced model 104-4 so that additional richness and refinement 218 can be added iteratively. For instance, a software programmer might prompt the AI tool 112 by inputting a text-based description of a desired AI-enhanced model:

“I'd like to model a process flow for a user logging in and validating, doing a two-factor authentication, and then validating the email address.”

The created AI enhanced model 104-4 can then be visually displayed.

Subsequent modifications can be made in refinement step 218. For example, the developer could provide a prompt such as

“Also make sure that the password has at least eight characters, that it has your specifications.”

and the AI would respond with refined artifacts for the abstract model 104.

In this way, the developer 111 may continue to enhance and refine artifacts of the AI-enhanced model 104-4, include a flow or an API diagram or a UML artifact, some other diagrammatic model.

Procedural conversion and rendering 214 may provide an output in various open-source language technologies. Using available technology, of many different technologies, programmatic output is seamlessly embedded into visual representation. As an example, one technology basically renders output better as visual via HTTP in a web feed so the output can be visualized. State diagrams in the process may also be automatically rendered. As quickly as the concept is verbalized and spoken the language output is converted and rendered 214 in real time.

If the initial model 104-1 is an abstract model 104-3, DXterity 100 and a resulting AI enhanced abstract model 104-6 provide flexibility of scale by generating an entire architecture as well as providing the capability of being able to focus on a single method at a time within an entire software solution. They are not to be confused with other AI tools that are only able to generate code for a single method or code snippets.

For example, a software developer using the DXterity AI code authoring 106 process can create an entire software solution and then make refinements and enhancements to a login page with language prompts fed to AI tools. Model enhancement 111 understands the refinements, and injects the refinements into the initial model 104-1 to provide an AI enhanced model 104-4—essentially enabling management of thousands of code snippets and where they fit into an overall solution, rendering that refinement as an artifact and captures the refinement in the code base.

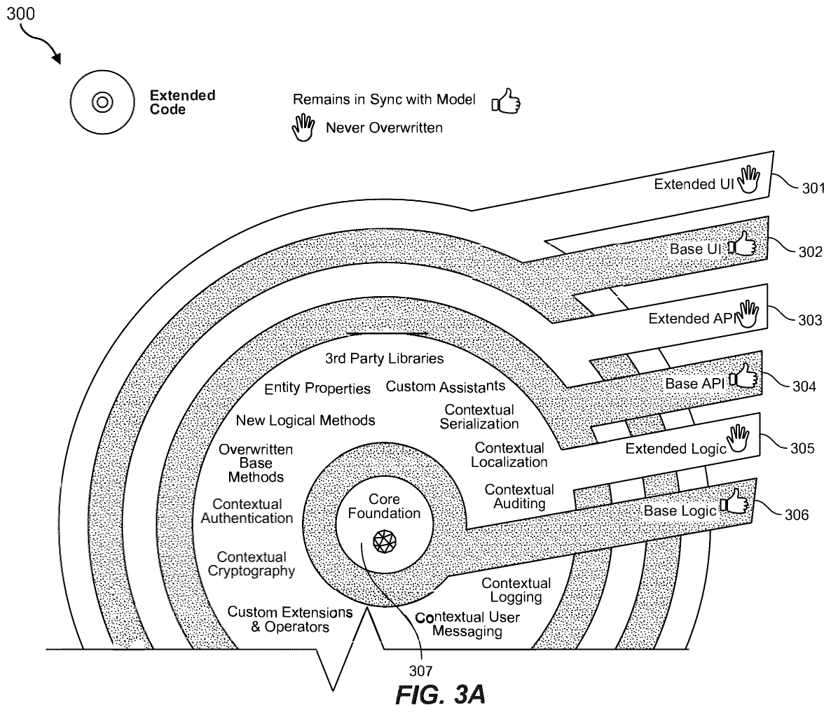

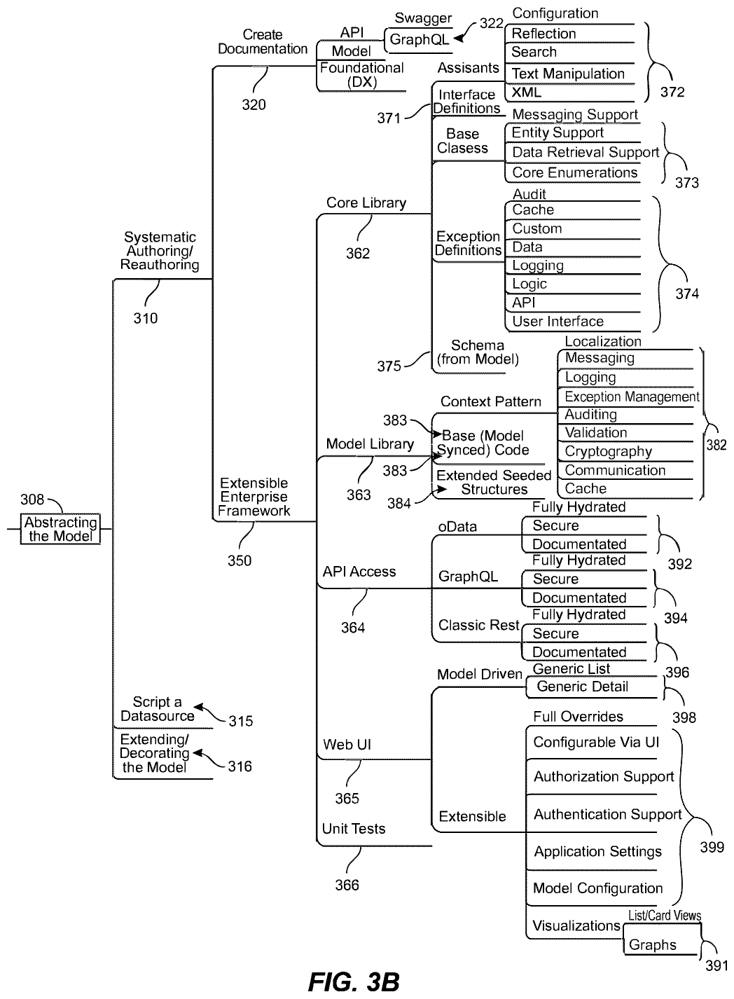

FIGS. 3A and 3B depict the type of output that may be produced from the AI code author 106 as per step 222 of FIG. 2. These artifacts are enhanced to provide an AI enhanced abstract model 104-6. The AI enhanced abstract model 104-6 is then utilized by the DXterity AI code author to generate more of the base code using the AI code author (as well as extended code, API and/or documentation) as further described in one or more of the patents and patent applications referenced above. This thereby reduces the dependency on the need for extending code in order to meet specialized customer requirements. DXterity 100 defines an entire work process and generates the base code for a fully functioning enterprise-level software solution.

FIG. 3A illustrates an example hierarchy of the generated code from an enhanced abstract model 104-6. More particularly, the generated code may be divided into a core code foundation 307, and application-specific logic including base logic 306 and extended application logic 305. API code is also arranged as base API code 304 and extended API code 303. Web UI code similarly includes base UI code 302 and extended UI code 301. The different code elements including base application logic 306 and extended application logic 305 are stored separately from one another, such as in different files. Similarly, base 304 and extended 303 API code are stored separately from one another, as are UI base 302 and extended 301 elements.

The core code 307 may consist of elements that are used by more than one application or solution. For example, the core code may include common libraries and similar functions.

The base components specific to the application, such as base logic 306, base API 304 and base UI 302 may be generated from the abstract model and always remain in sync with the model. Therefore, even though the developer is permitted to view and even edit the base application code 306, base API code 304 and UI base code 302, these base components will be rewritten whenever the developer requests code to be re-generated from the model.

The generated structures (or frameworks) may be used by the developer for placement of extended code including extended application code 305, extended API code 303 and extended UI code 301. These frameworks may thus be exposed to a developer for review (such as a data architect) and also made available for modification. These extended code elements (which may include code, attributes, properties, or rules), once modified, are prevented from being overwritten by any subsequent regeneration of code. However, in some implementations, the extended code elements may be permitted to be overwritten before any developer modifications are made to them. In some implementations, extended UI code may be stored in a configuration file to, for example, enable late binding as explained elsewhere.

More particularly, FIG. 3B is but one example of a hierarchical list of the functions, structures, and concepts that may be performed or authored by the DXterity platform 100 and enhanced by model enhancement 111. It should be understood that this is one example, and that other implementations and uses of model enhancement 111 are possible.

An abstracting function 308 takes a data model (such as an AI-enhanced data model 104-5) and generates an abstract model 104-3. The abstract model 104-3 may then be further AI enhanced to produce an enhanced abstract model.

From the enhanced abstract model 104-6, systematic authoring/re-authoring functions 310 may then proceed. Systematic authoring 310 consists of generating the extensible enterprise framework as executable code 350 as well as creating the related documentation 320.

Other functions or operations such as scripting a data source or extending 315 and decorating 316 may also be performed on the abstract model.

The generated extensible framework 350 architects the authored (generated) code in a particular way. More specifically, the code generated may be arranged into a core library 362, model library 363, API access 364, web UI 365 and unit test 366 elements.

In an example implementation, the core library 362 may further include code grouped as assistant functions 372 (including configuration parameters, reflectors, search, text manipulation, and XML), interface definitions 371, base classes 373 (including messaging support, entity support, data retrieval support, or core enumerations), exception definitions 374 (including audit, cache, custom, data, login, logic, API, and user interface, as well as schema definitions 375.

The model library 363 may involve generating context patterns 382 (including localization, messaging, logging, exception management, authoring, validations, cryptography, communication and caching), base code 383, and extended structures 384.

API access 364 may be generated in any of several API formats including OData 392, GraphQL 394, or REST 396 each of which may be accordingly hydrated, secured and documented.

The generated web UI 365 artifacts are also driven 398 from the abstract model in which case generic list and generic details are provided; or they may be extensible (including overrides, configurations, authorization and authentication support with application settings 399 and/or model configurations and/or visualizations 391.

In summary, the overall process is to use AI-based model enhancement 111 to improve an initial model 104-1 before it is submitted to a code author 106. The AI 112 can be leveraged to enhance the initial model 104-1 in a variety of different ways. In one example, the model enhancement process 111 can identify parts of an initial model 104-1 (such as UML artifacts) and suggest revisions to that model, according to a series of prompts by the developer to the AI 112. The result of this interaction with the AI 112 is then used to revise or augment the initial model 104-1 resulting in an AI-enhanced model 104-4. In one example, the outputs from the model enhancement process 111 modify the initial model 104-1. In other examples, the outputs are stored as a separate AI enhanced model 104-4. Ultimately, the AI-enhanced model 104-4 is consumed by the code author 106 to generate a more complex or more complete application source code.

The following discussion explains several use cases in more detail. These examples are presented as a series of questions performed interactively between a human software developer 111 and an AI tool 112—here the tool being used is ChatGPT. However, an analogous process may also be performed automatically or programmatically through an API interface provided between the AI 112 and an API for the code author (such as the DXterity API mentioned above).

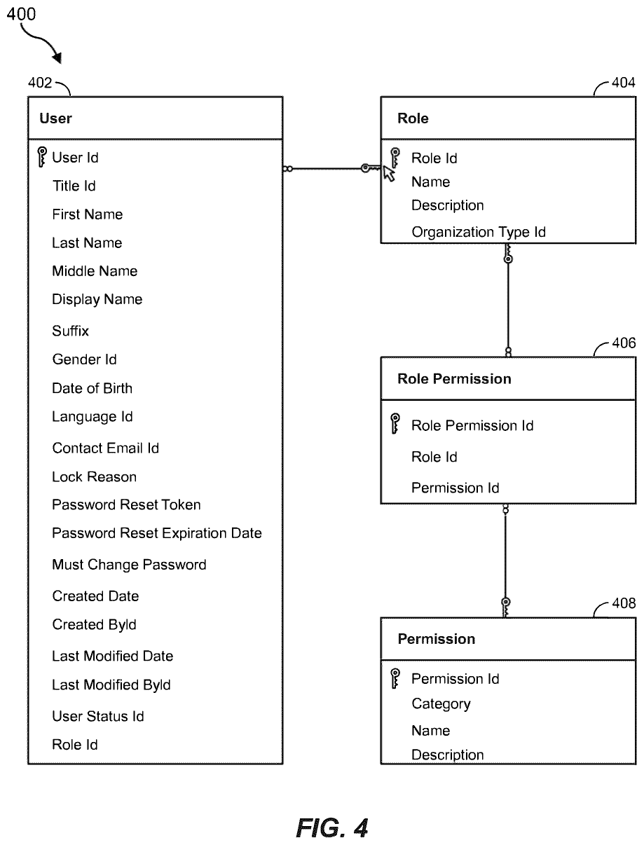

FIG. 4 shows a visual representation 400 of an artifact of an initial model 104-1. The initial model artifact may originate from a data model 104-2 or an abstract model 104-3 (either of which may or may not be generated by DXterity 100). This example of an initial model 104-1 is a data model 104-2 that consists of one or more tables including a user table 402, a role table 404, a role permission table 406, and a permission table 408. The model artifact can be used to define certain attributes of the users of a system, the user's roles, and the permissions associated with a role, a set of permissions, and which permissions a user with a certain role is granted. The user table 402 may store information such as the user's name, gender, date of birth, and passwords, the role table 404 may describe their job, the permissions table may define what they are authorized to do. For example, a user who is responsible for maintaining the company's servers may have greater permission to access data processing infrastructure than a clerk in the accounting department.

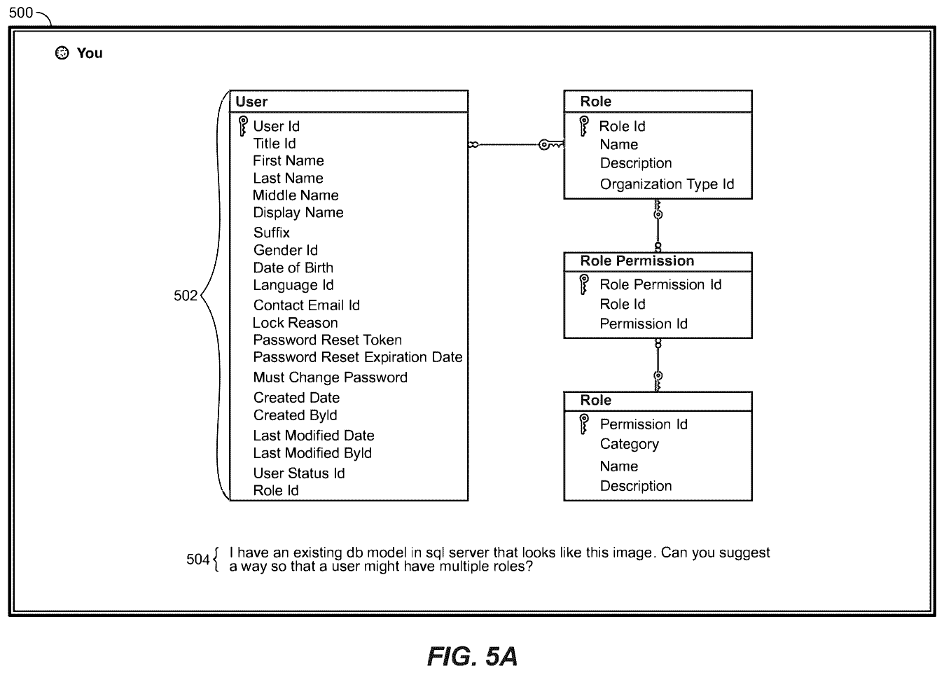

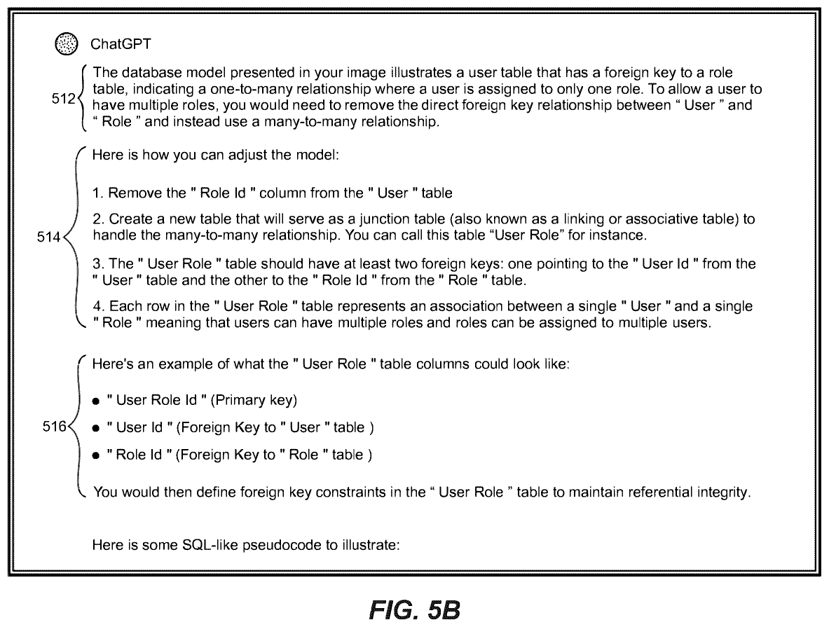

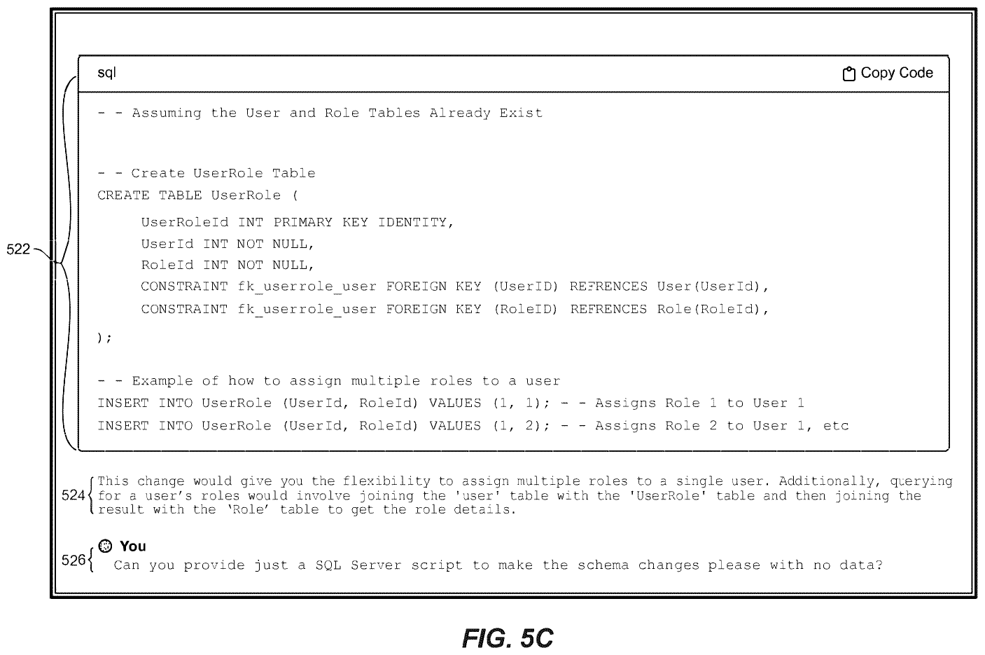

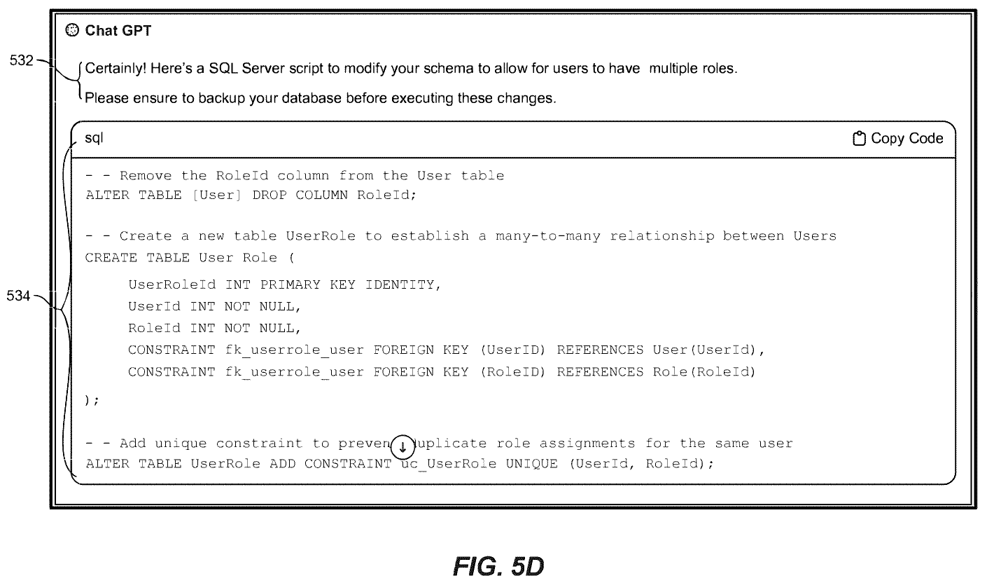

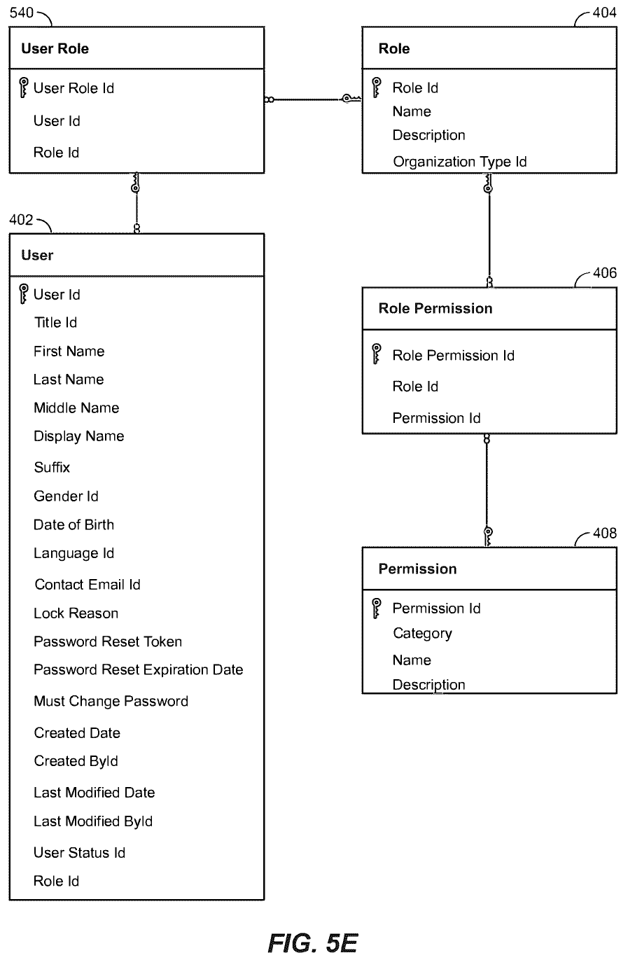

FIG. 5A is the first in a series of illustrations showing how the developer 110 may utilize AI-driven model enhancement 111 to enhance the initial model 104-1 of FIG. 4. FIG. 5A is an example user screen where a developer is interacting with a ChatGPT generative AI tool 112. The developer's inputs are indicated by the name “You”. The developer has first asked the system to display a visual rendering of the model of FIG. 4. At 504 the user provides a prompt to ChatGPT 112 that they have an existing database model and a SQL Server that looks like the image displayed. The user asks ChatGPT to suggest how to modify the initial model 104-1 so that each user might have multiple roles.

The interaction with the developer then proceeds to FIG. 5B where at 512 ChatGPT responds with its initial interpretation of the model. ChatGPT responds that it understands the model presented in the image illustrates a user table that has a foreign key to a role table that indicates a one-to-many relationship where a user is only assigned to a single role. ChatGPT is suggesting that to allow a user to have multiple roles, the schema should be modified to remove the direct foreign key relationship between the “user” table and the “role” table and instead use a many to many relationship. At 514 ChatGPT provides a particular suggestion for how to accomplish that by removing the “role ID” column from the user table, creating a new table “user role” and providing the new user role table with at least two foreign keys, with one pointing to the user ID in the user table and the other to the role ID from the role table. ChatGPT also explains that with this change, each row in the user table would then represent an association between a single “user” and a “role” meaning that the users can now have multiple roles.

At 516 ChatGPT is providing a further suggestion for how the user role table might look, with an explanation of what the foreign key constraints in that table might be in order to maintain referential integrity.

At 518 ChatGPT refers to some SQL-like pseudo code that might implement the result and this result is seen at 522 in FIG. 5C. At 524 ChatGPT further explains that the proposed enhancement would provide the flexibility to assign multiple roles to a single user, so that querying for a user's role would involve joining the user table with the user role table, and then joining the result with the role table.

At 526 the developer is asking ChatGPT to provide a SQL Server script to just implement changes to the schema with no data.

At FIG. 5D, ChatGPT's response at 532 explains that it has generated a SQL Server script to modify the schema and at 534 displays that script.

FIG. 5E illustrates the result of applying the suggested script to the initial model 104-1 thus resulting in the AI-enhanced model 104-4 (which in this case is an enhanced data model 104-5). The user table 402, role table 404, role permission table 406 and permission table 408 have not been modified and are as per FIG. 4. However, a new user role table 540 has been added in the enhanced model 104-4. In addition, the relations suggested by the AI tool have been added between the tables.

This enhanced data model may be then submitted to the DXterity abstraction function 308 to generate an enhanced abstract model 104-6 that can then be used by the DXterity code author 106.

In other example workflows, an initial data model 104-2 might first be submitted to the abstraction function 308 to generate an initial abstract model 104- 3. That initial abstract model may then be submitted to AI based model enhancement 111 to generate the enhanced abstract model 104-6.

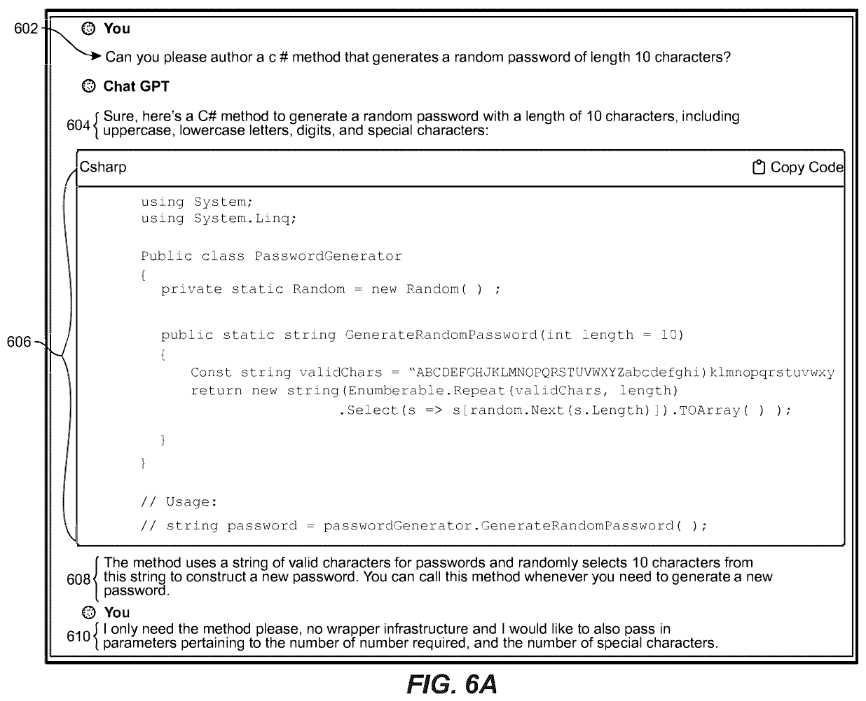

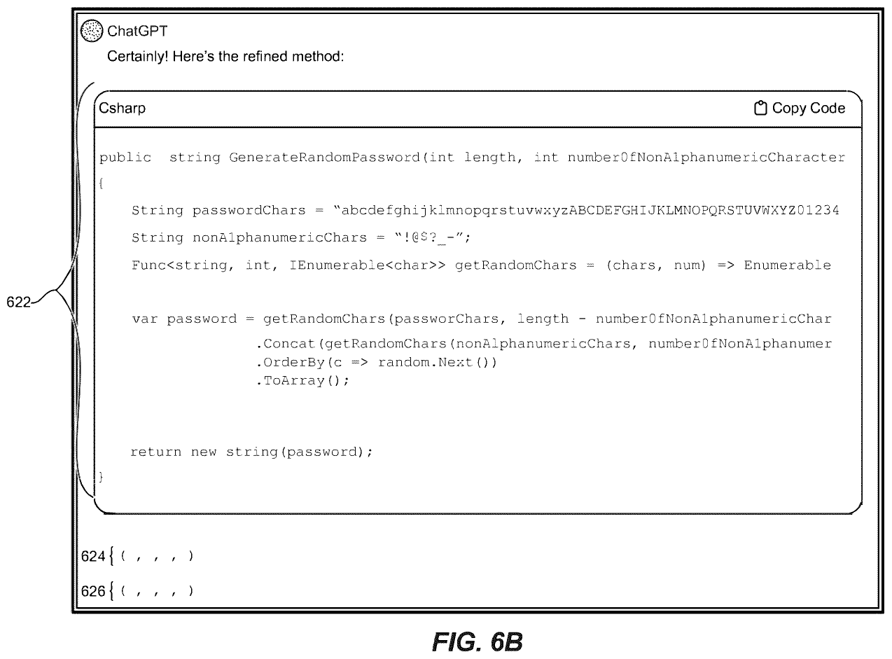

FIGS. 6A and 6B are another example of AI based model enhancement 111. Here the enhancement is made to a work flow such as a DXterity flow. In this example, the developer at 602 is asking ChatGPT to author a method that generates a random password of ten characters in length. At 604 ChatGPT responds with some explanation of what it did, and shows its suggested method at 606. At 608 ChatGPT is further explaining that the particular method uses a string of characters for passwords and randomly selects 10 characters from the string to construct the new password.

At 610 the developer 110 indicates that she only needs the method, does not need any wrapper infrastructure, and that she would also like to pass as input parameters the number of characters required and the number of special characters.

At 622 ChatGPT responds with a refined method. In subsequent steps a new model attribute is created to store the code in an AI enhanced abstract model 104-6 at state 624 and at state 626 the code is added to the base class of the appropriate artifact in the enhanced abstract model 104-6.

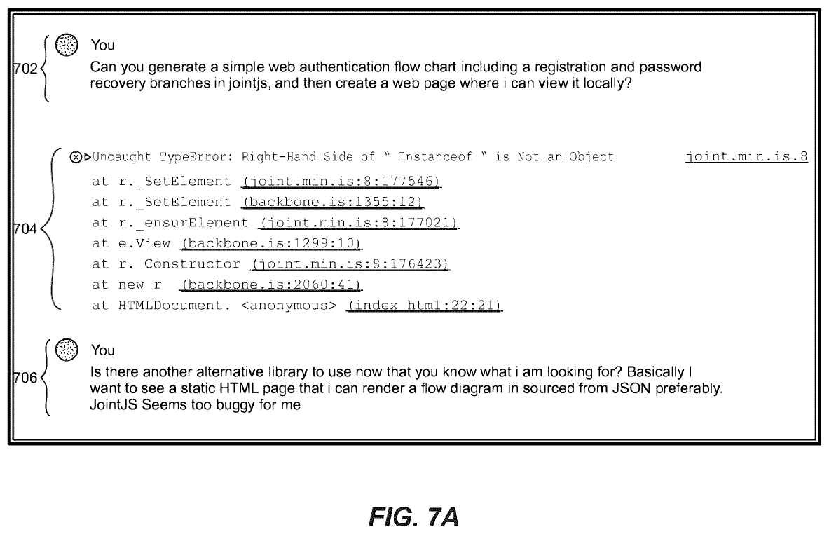

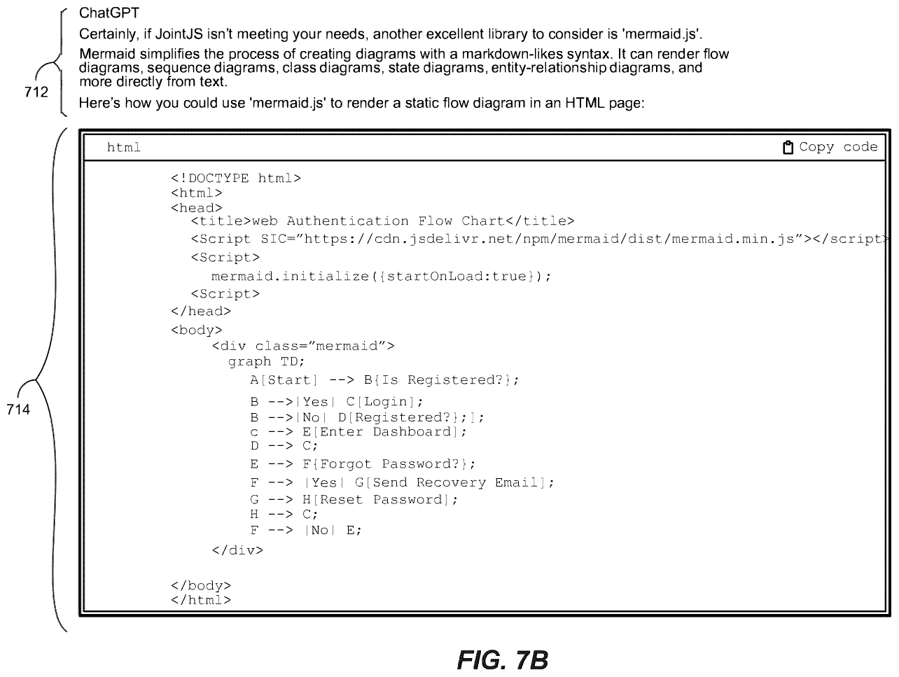

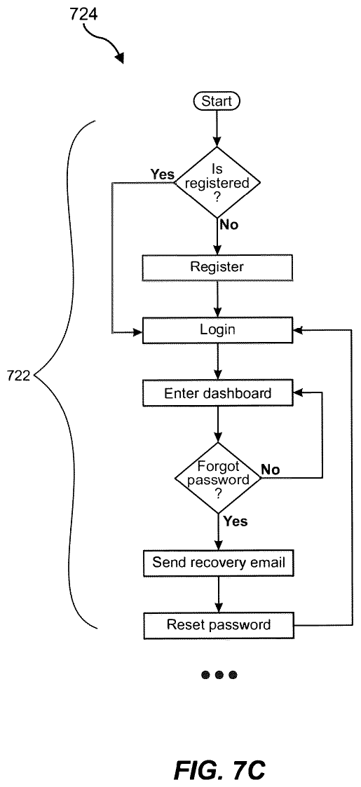

FIGS. 7A and 7B show an example of how AI enhancement 111 can add a function to an initial abstract model 104-3.

At 702 the developer is asking ChatGPT to generate a web authentication flow, including registration and password recovery, using Joint JavaScript as the language, and to then create a web page where he can review the result. Several iterations and prompts then occur, with multiple failed attempts for the developer to obtain the result they are looking for. However, at 706 the developer asks ChatGPT if there is an alternative library to provide the requested static HTML page to render a flow diagram, such as one sourced in JSON. Proceeding to FIG. 7B, at 712 ChatGPT suggests that a library called mermaid.js might be appropriate because it has a markdown like syntax and can render flow diagrams.

At 714 ChatGPT displays the mermaid JavaScript file that it found, and at 722 ChatGPT renders the requested web page as shown at 724. The developer can then store this flow as another artifact in the AI-enhanced abstract model 104-6, thereby effectively extending the initial abstract model 104-3.

### Further Implementation Options

It should be understood that the example embodiments described above are not intended to be exhaustive or limited to the precise form disclosed, and thus may be implemented in many different ways. In some instances, the various “data processors” may each be implemented by a separate or shared physical or virtual or cloud-implemented general-purpose computer having or having access to a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments of the components may therefore typically be implemented in hardware, firmware, software or any combination thereof. In some implementations, the computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that may be rapidly provisioned and released with minimal management effort or service provider interaction. Such cloud computing deployments are relevant and typically preferred as they allow multiple users to access computing. By aggregating demand from multiple users in central locations, cloud computing environments may be built in data centers that use the best and newest technology, located in the sustainable and/or centralized locations and designed to achieve the greatest per-unit efficiency possible.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block, flow, network and code diagrams and listings may include more or fewer elements, be arranged differently, or be represented differently.

Other modifications and variations are possible in light of the above teachings. For example, while a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

Certain portions may be implemented as “logic” that performs one or more functions. This logic may include hardware, such as hardwired logic, an application-specific integrated circuit, a field programmable gate array, a microprocessor, software, wetware, or a combination of hardware and software. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Also, the term “user”, as used herein, is intended to be broadly interpreted to include, for example, a computer or data processing system or a human user of a computer or data processing system, unless otherwise stated.

Also, the terms “developer”, “programmer” and “designer” as used herein, are intended to refer to a particular type of user who is enabled to create software applications or systems that run on a computer or another device; analyze other users' needs and/or then design, develop, test, and/or maintain software to meet those needs; recommend upgrades for existing programs and systems; and/or design pieces of an application or system and plan how the pieces will work together.

The above description has particularly shown and described example embodiments. However, it will be understood by those skilled in the art that various changes in form and details may be made therein without departing from the legal scope of this patent as encompassed by the appended claims.

1. A method for generating code, the method comprising:
obtaining an initial model;
identifying an artifact of the model;
generating an enhancement of the artifact using an Artificial Intelligence (AI) tool;
revising the initial model according to the enhancement, to produce an AI-enhanced model; and
submitting the AI-enhanced model to a code author, thereby generating the code.

2. The method of claim 1 wherein the initial model is an abstract model of an artifact of a database.

3. The method of claim 1 wherein the code author is AI based code author.

4. The method of claim 1 wherein the initial model is obtained using the AI tool.

5. The method of claim 1 wherein generating the enhancement of the artifact further comprises a series of interactive prompts with a human user.

6. The method of claim 1 wherein the AI tool has an Application Programming Interface (API), and enhancement of the artifact further comprises an automated process using the API.

7. The method of claim 1 wherein the initial model and the AI-enhanced model are specified in Universal Modeling Language (UML).

8. The method of claim 1 wherein the enhancement is a change or addition to one or more tables in the initial model.

9. The method of claim 1 wherein the enhancement is a functional enhancement to the initial model.

10. The method of claim 1 wherein the enhancement is a flow enhancement to the initial model.

11. The method of claim 1 wherein the enhanced model is stored separately from the initial model.

12. A method for generating code from an initial abstract model of a database, comprising:
modifying an attribute of the initial abstract model using an artificial intelligence (AI) tool to produce an AI-enhanced model;
generating base application code from the AI-enhanced model;
generating an extended application code structure for subsequent placement of extended application code, wherein components of the extended application code may include one or more code extensions, attributes, properties or rules that are specified other than by generating from the AI-enhanced model;
storing the extended application code structure separately from the base application code;
exposing the base application code and extended application code structure for developer review; and
accepting developer modifications, if any, to the base application code; and wherein the code structure further comprises patterns that define further aspects of the base application code.

13. A method for generating code from an initial abstract model of a database, comprising:
identifying an artifact of the initial abstract model;
generating an enhancement of the artifact using an Artificial Intelligence (AI) tool;
revising the initial abstract model according to the enhancement, to produce an AI-enhanced abstract model; and
submitting the AI-enhanced abstract model to a code author by:
generating base application code from the AI-enhanced abstract model;
generating an extended application code structure for subsequent placement of extended application code, wherein components of the extended application code may include one or more code extensions, attributes, properties or rules that are specified other than by generating from the AI-enhanced abstract model;
storing the extended application code structure separately from the base application code;
exposing the base application code and extended application code structure for developer review;
accepting developer modifications, if any, to the base application code;
accepting developer modifications, if any, to the components of the extended application code structure;
accepting developer modifications to the AI-enhanced abstract model to provide a revised model; and
regenerating code by:
overwriting any developer modifications to the base application code by regenerating the base application code from the revised model; and
otherwise preventing any overwriting of the components of the extended application code structure after such developer modification are made to the components of the extended application code.

14. A system for generating code from an abstract model, comprising:
a computing platform having one or more processors and one or more computer readable memory devices;
program instructions embodied by the one or more computer readable memory devices, the program instructions causing one or more of the processors, when executed, to generate the code by further:
obtaining an initial model;
identifying an artifact of the model;
generating an enhancement of the artifact using an Artificial Intelligence (AI) tool;
revising the initial model according to the enhancement, to produce an AI-enhanced model; and
submitting the AI-enhanced model to a code author, thereby generating the code.

15. The system of claim 14 wherein the initial model is an initial abstract model of a database and wherein the code author is further for
generating base application code from the AI-enhanced model;
generating an extended application code structure for subsequent placement of extended application code, wherein components of the extended application code may include one or more code extensions, attributes, properties or rules e that are specified other than by generating from the AI-enhanced abstract model;
storing the extended application code structure separately from the base application code;
exposing the base application code and extended application code structure for developer review;
accepting developer modifications, if any, to the base application code;
accepting developer modifications, if any, to the components of the extended application code structure;
accepting developer modifications to the AI-enhanced abstract model to provide a revised model; and
regenerating code by:
overwriting any developer modifications to the base application code by regenerating the base application code from the revised model; and
otherwise preventing any overwriting of the components of the extended application code structure after such developer modification are made to the components of the extended application code.

16. The system of claim 14 wherein the initial model is an initial abstract model of a database and wherein the code author is further for
generating base application code from the AI-enhanced model;
generating an extended application code structure for subsequent placement of extended application code, wherein components of the extended application code may include one or more code extensions, attributes, properties or rules e that are specified other than by generating from the AI-enhanced abstract model;
storing the extended application code structure separately from the base application code;
exposing the base application code and extended application code structure for developer review;
accepting developer modifications, if any, to the base application code;
accepting developer modifications, if any, to the components of the extended application code structure;
accepting developer modifications to the AI-enhanced abstract model to provide a revised model; and
regenerating code by:
overwriting any developer modifications to the base application code by regenerating the base application code from the revised model; and
otherwise preventing any overwriting of the components of the extended application code structure after such developer modification are made to the components of the extended application code.
